(19) United States
(12) Patent Application Publication
(10) Pub. No.: US 2023/0289618 A1
(43) Pub. Date: Sep. 14, 2023

(54) PERFORMING KNOWLEDGE GRAPH EMBEDDING USING A PREDICTION MODEL

(71) Applicant: International Business Machines Corporation, Armonk, NY (US)

(72) Inventor: Toshihiro Takahashi, Tokyo (JP)

(21) Appl. No.: 17/690,762

(22) Filed: Mar. 9, 2022

(51) Int. Cl. G06N 5/02; G06N 5/04; G06N 5/00

(52) U.S. Cl. CPC G06N 5/02; G06N 5/04; G06N 5/003

(57) ABSTRACT

A computer-implemented method, system and computer program product for knowledge graph embedding. A node pair for each triple of a knowledge graph is selected and a direct relation path between the selected node pair is identified. Furthermore, for each triple, a set of relation paths between the selected node pair is collected except for a path representing the direct relation path. The number of occurrences of each relation path for each triple in the collected set of relation paths is counted thereby forming a feature vector set for each triple, where the feature vector set includes a set of occurrences of each relation path for a node pair along with a corresponding direct relation path. A prediction model is then constructed using the feature vector set for each triple to predict an unknown direct relation path between two target nodes in the knowledge graph.

### TECHNICAL FIELD

The present disclosure relates generally to knowledge representation and reasoning, and more particularly to performing knowledge graph embedding using a prediction model.

### BACKGROUND

In knowledge representation and reasoning, a knowledge graph is a knowledge base that uses a graph-structured data model or topology to integrate data. That is, a knowledge graph is a model of a knowledge domain created by domain experts with the help of machine learning algorithms. It provides a structural representation of knowledge and a unified interface for the structured data, which enables the creation of smart multilateral relations throughout the database. In recent years, a large amount of knowledge graphs has been created and successfully applied to many real-world applications, such as semantic parsing, information extraction, etc.

### SUMMARY

In one embodiment of the present disclosure, a computer-implemented method for knowledge graph embedding comprises selecting a node pair for each triple of a knowledge graph and identifying a direct relation path between the node pair, where the triple of the knowledge graph comprises a first and a second node each representing an entity connected by a specific relation path. The method further comprises collecting a set of relation paths between the node pair except for a path representing the direct relation path for each triple of the knowledge graph. The method additionally comprises counting a number of occurrences of each relation path for each triple in the collected set of relation paths thereby forming a feature vector set for each triple, where the feature vector set comprises a set of occurrences of each relation path for a node pair along with a corresponding direct relation path. Furthermore, the method comprises constructing a prediction model by using the feature vector set for each triple to predict a direct relation path between two target nodes in the knowledge graph by obtaining a feature vector set corresponding to the two target nodes.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the knowledge graph embedding generator used for accurately and efficiently performing knowledge graph embedding in accordance with an embodiment of the present disclosure;

FIG. 3 illustrates collecting a set of relation paths between the two nodes of a triple in a knowledge graph except for the direct relation path between the two nodes of the triple in accordance with an embodiment of the present disclosure;

FIG. 4 illustrates an embodiment of the present disclosure of the hardware configuration of the knowledge graph embedding generator which is representative of a hardware environment for practicing the present disclosure;

FIG. 5 is a flowchart of a method for improving the accuracy and efficiency of performing knowledge graph embedding in accordance with an embodiment of the present disclosure;

FIG. 6 is a flowchart of a method for counting the number of occurrences of a relation path in accordance with an embodiment of the present disclosure.

### DETAILED DESCRIPTION

As stated in the Background section, in knowledge representation and reasoning, a knowledge graph is a knowledge base that uses a graph-structured data model or topology to integrate data. That is, a knowledge graph is a model of a knowledge domain created by domain experts with the help of machine learning algorithms. It provides a structural representation of knowledge and a unified interface for the structured data, which enables the creation of smart multilateral relations throughout the database. In recent years, a large amount of knowledge graphs has been created and successfully applied to many real-world applications, such as semantic parsing, information extraction, etc.

A knowledge graph is a multi-relational graph composed of entities (nodes) and relations (edges). Each edge is represented by a “triple” of a form (e.g., head, relation, tail), also called a fact, indicating that two entities are connected by a specific relation. Although effective in representing structured data, the underlying symbolic nature of such triples usually makes knowledge graphs hard to manipulate.

As a result, knowledge graph embedding has recently been utilized to address this issue. Knowledge graph embedding is a machine learning task of learning a low-dimensional representation of a knowledge graph's entities and relations while preserving their semantic meaning. Leveraging their embedded representation, knowledge graphs can be used for various applications, such as link prediction, triple classification, entity recognition, clustering and relation extraction.

For example, knowledge graph embedding involves embedding components of a knowledge graph, including entities and relations, into continuous vector spaces so as to simplify the manipulation which preserving the inherent structure of the knowledge graph. Such entity and relation embedding can further be used to benefit many different types of tasks, such as entity classification, relation extraction, etc. Example algorithms for knowledge graph embedding include TransE (Translating Embeddings) and RotatE.

In TransE, relationships are represented as translations in the embedding space. In RotatE, the RotatE model defines each relation as a rotation from the source entity to the target entity in a complex vector space. While such algorithms are simple and easy to use to perform knowledge graph embedding, the accuracy is poor.

Alternatively, an attention-based neural network may be utilized to perform knowledge graph embedding. Unfortunately, such neural network models are complex to be utilized resulting in processor and memory inefficiencies.

As a result, there is not currently a means for accurately and efficiently performing knowledge graph embedding.

The embodiments of the present disclosure provide a means for accurately and efficiently performing knowledge graph embedding by utilizing a prediction model to predict the unknown direct relation path between two target nodes of a knowledge graph by utilizing a feature vector set of the two target nodes as discussed further below.

In some embodiments of the present disclosure, the present disclosure comprises a computer-implemented method, system and computer program product for knowledge graph embedding. In one embodiment of the present disclosure, a node pair for each triple of a knowledge graph is selected and a direct relation path between the selected node pair is identified. A “triple” of the knowledge graph, as used herein, refers to the form, also called a fact, which includes two entities as well as a relation connecting the two entities. An “entity,” as used herein, refers to the node of the knowledge graph, which may represent a person, a place, an object, etc. The term “entity” and “node” are used interchangeably herein. A “relation,” as used herein, refers to the edge or path of the knowledge graph that connects the nodes of the knowledge graph. A “direct relation path,” as used herein, refers to the relation path that directly connects two nodes in the knowledge graph in a closed loop in the shortest distance. A “closed loop,” as used herein, refers to a connection between two nodes in a knowledge graph in which the two nodes correspond to the end points of the connection. Furthermore, for each triple of the knowledge graph, a set of relation paths between the selected node pair is collected except for the path representing the direct relation path. The number of occurrences of each relation path for each triple in the collected set of relation paths is counted thereby forming a feature vector set for each triple, where the feature vector set includes a set of occurrences of each relation path for a node pair along with a corresponding direct relation path. A prediction model is then constructed using the feature vector set for each triple to predict an unknown direct relation path between two target nodes in the knowledge graph by obtaining a feature vector set corresponding to the two target nodes, which includes the number of occurrences for various relation paths as well as a direct relation path. Based on obtaining the number of occurrences of each relation path connecting the two target nodes, the unknown direct relation path can be predicted for the two target nodes based on obtaining the feature vector set of the two target nodes containing the number of occurrences (or most similar number of occurrences) of each relation path (or most similar relation path) connecting the two target nodes. In this manner, knowledge graph embedding is performed more accurately and efficiently than prior techniques. The technique of the present disclosure utilizes fewer resources (e.g., processing and memory resources) while more accurately predicting the direct relation paths than prior techniques as evidenced by a higher mean reciprocal rank than prior techniques.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill the relevant art.

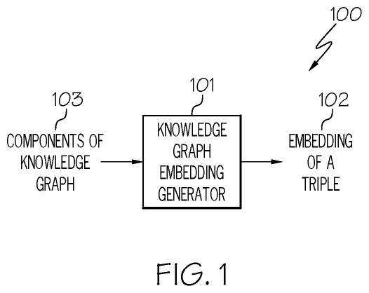

Referring now to the Figures in detail, FIG. 1 illustrates an embodiment of the present disclosure of a communication system 100 for practicing the principles of the present disclosure. Communication system 100 includes a knowledge graph embedding generator 101 configured to generate an embedding of a triple 102 based on receiving the components of the knowledge graph 103, such as the entities and the relations between such entities on the knowledge graph.

As previously discussed, a knowledge graph is a multi-relational graph composed of entities (nodes) and relations (edges). Each edge is represented by a triple of a form (e.g., head, relation, tail), also called a fact, indicating that two entities are connected by a specific relation. In one embodiment, based on the receipt of the components of the knowledge graph 103, such as two entities and a relation between such two entities, knowledge graph embedding generator 101 generates an embedding of such a form (called a triple) 102, which includes the two entities and a relation.

In one embodiment, knowledge graph embedding generator 101 performs knowledge graph embedding which involves translating each entity and relation of a knowledge graph into a vector of a given dimension, called an embedding dimension. In one embodiment, knowledge graph embedding generator 101 generates different embedding dimensions for the entities and the relations. The collection of embedding vectors for all the entities and relations in the knowledge graph are a more dense and efficient representation of the domain that can more easily be used for many tasks. As a result, a knowledge graph embedding is characterized by a low-dimensional space in which the entities and relations are represented.

As previously discussed, knowledge graphs are built to store structured facts, which are encoded as triples. Large-scale knowledge graphs may contain billions of triples and have been widely applied in various fields. However, a common problem with these knowledge graphs is that the relation between the two entities of a triple may or may not be true. Hence, there has been a recent focus in predicting whether a relationship between the two is likely to be true, which is defined as the “link prediction” in knowledge graphs.

In one embodiment, knowledge graph embedding generator 101 performs link prediction by predicting the direct relation (a previously unknown direct relation) between the two entities of a triple that is likely to be correct. A further description of these and other features is provided further below.

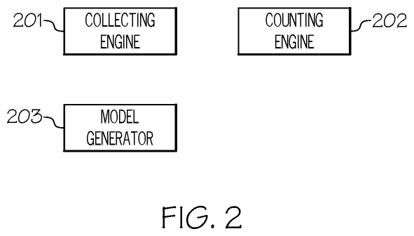

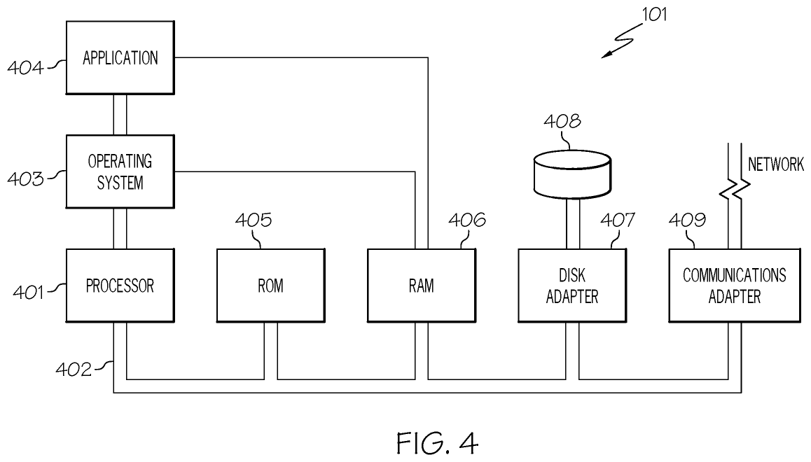

A description of the software components of knowledge graph embedding generator 101 used for more accurately and efficiently performing knowledge graph embedding is provided below in connection with FIG. 2. A description of the hardware configuration of knowledge graph embedding generator 101 is provided further below in connection with FIG. 4.

As stated above, FIG. 2 is a diagram of the software components of knowledge graph embedding generator 101 used for accurately and efficiently performing knowledge graph embedding in accordance with an embodiment of the present disclosure.

Referring to FIG. 2, in conjunction with FIG. 1, knowledge graph embedding generator 101 includes a collecting engine 201 configured to select a node pair in the knowledge graph for each triple and identify a direct relation path between each selected node pair.

A “triple,” as used herein, refers to the form, also called a fact, which includes two entities as well as a relation connecting the two entities. An “entity,” as used herein, refers to the node of the knowledge graph, which may represent a person, a place, an object, etc. The term “entity” and “node” are used interchangeably herein. A “relation,” as used herein, refers to the edge or path of the knowledge graph that connects the nodes of the knowledge graph. As discussed above, a “direct relation,” or a “direct relation path,” as used herein, refers to the relation path that directly connects the two nodes in the knowledge graph in a closed loop manner in the shortest distance. A “closed loop,” as used herein, refers to a connection between two nodes in a knowledge graph in which the two nodes correspond to the end points of the connection.

Furthermore, in one embodiment, collecting engine 201 collects a set of all relation paths between the selected node pair except for a path representing the direct relation path between the selected node pair node for each triple of the knowledge graph.

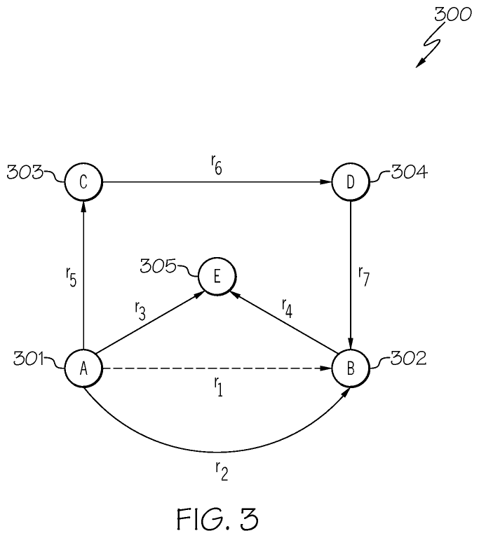

An illustration of collecting engine 201 collecting a set of all relation paths between two nodes of a knowledge graph except for the direct relation path between the two nodes is provided in FIG. 3.

FIG. 3 illustrates collecting a set of relation paths between the two nodes of a triple in knowledge graph 300 except for the direct relation path between the two nodes of the triple in accordance with an embodiment of the present disclosure.

Referring to FIG. 3, collecting engine 201 identifies various relation paths between node A 301 and node B 302 in knowledge graph 300, such as relation path r5→r6→r7, which corresponds to the relation path between node A 301 and B 302 that includes nodes C 303 and D 304 as shown in FIG. 3.

In another example, collecting engine 201 identifies the relation path r3→r4, which corresponds to the relation path between node A 301 and B 302 in knowledge graph 300 that includes node E 305 as shown in FIG. 3.

In a further example, collecting engine 201 identifies the relation path r2 between nodes A 301 and B 302 in knowledge graph 300 as shown in FIG. 3.

In one embodiment, such relation paths identified and collected by collecting engine 201 form a closed loop in knowledge graph 300 as shown in FIG. 3.

In one embodiment, each relation path in the set of relation paths does not include node information. For example, the following two relation paths would be the same: “A→r5→C →r6→D→r7→B” and “W→r5→X→r6→Y→r7→Z.”

Furthermore, as shown in FIG. 3, the path representing the “direct relation” path, such as r1, is not collected by collecting engine 201.

In one embodiment, collecting engine 201 selects a node pair of the knowledge graph randomly. In one embodiment, collecting engine 201 receives user input to select the node pair of the knowledge graph, such as via the user interface of knowledge graph embedding generator 101.

In one embodiment, collecting engine 201 collects, for each triple, the set of all relation paths between two nodes of a triple of a knowledge graph, except for a path representing the direct relation between the two nodes, by defining every relation path with an associated path extension that consists of a pair of entities. For example, for the pair of entities A and B, collecting engine 201 follows a relation path P if the pair (A; B) is a member of the relation path extension PEXT(P). In one embodiment, the size of the relation path extension corresponds to the number of valid connecting paths for any pair of nodes in the knowledge graph.

In one embodiment, collecting engine 201 utilizes various algorithms, such as breadth-first and depth-first, to identify all the relation paths between the two nodes of a triple except for the path representing the direct relation. In one embodiment, such algorithms start from a given node (e.g., node A 301 in FIG. 3) and iterate over all potential paths until they reach the destination node (e.g., node B 302 in FIG. 3).

In one embodiment, collecting engine 201 identifies the direct relation path so as to not collect the direct relation path by identifying the optimal path between the two nodes. Such an optimal path corresponds to the path that directly connects the two nodes in the knowledge graph in a closed loop manner in the shortest distance. In one embodiment, collecting engine 201 utilizes the Bellman-Ford algorithm to identify such an optimal path. In another embodiment, collecting engine 201 utilizes the A* algorithm or Dijkstra's algorithm to identify such an optimal path, which strategically eliminates paths, either through heuristics or through dynamic programming.

Knowledge graph embedding generator 101 further includes a counting engine 202 configured to count the number of occurrences of each relation path for each triple in the collected set of relation paths forming a feature vector set for each triple. The “feature vector set,” refers to a set of occurrences of each relation path for a node pair along with a corresponding direct relation path. For example, referring to FIG. 3, for the triple involving nodes A 301 and B 302, counting engine 202 determines that the number of occurrences of relation path “r2” to be 1, the number of occurrences of relation path “r3→rr4” to be 1, the number of occurrences of relation path “r5→r6→r7” to be 1 and the number of occurrences of other relation paths to be 0. When such relation paths occur between such target nodes (A 301 and B 302), with such a number of occurrences, the direct relation path is said to be “r1,” which was previously identified by collecting engine 201. Such information forms part of the feature vector set. In one embodiment, such feature vector sets are stored in a data storage device (e.g., memory, disk unit) of knowledge graph embedding generator 101. In one embodiment, there may be multiple feature vector sets involving the same pair of nodes (e.g., nodes A 301 and B 302) involving different relation paths and/or different number of occurrences of the same relation paths. The feature vector set for each triple is used by the prediction model to predict an unknown direct relation path between two target nodes in the knowledge graph as discussed further below.

In one embodiment, the feature vector set is formed by counting engine 202 obtaining a string representing a relation path (p) of the knowledge graph. For example, the relation path between nodes A 301 and B 302 in FIG. 3 may be represented by the string r5→r6→r7. In one embodiment, such strings correspond to the relation paths in the collected set of relation paths prepared by collecting engine 201.

In one embodiment, counting engine 202 obtains multiple strings representing each relation path (p) of the knowledge graph, where such strings correspond to the different relation paths in the collected set of relation paths prepared by collecting engine 201. For example, the relation path between nodes A 301 and B 302 in FIG. 3 may be represented by the strings r5→r6→r7, r3→r4 and r2. The relation path between nodes A 301 and D 304 in FIG. 3 may be represented by the strings r5→r6, r3→r4→r7, and r2→r7.

After obtaining a string representing a relation path of the knowledge graph, counting engine 202 computes hash values for the string using multiple hash algorithms. For example, counting engine 202 computes several hash values hᵢ(p) with seed i.

For example, in one embodiment, several different hash values are calculated for the string using different string hash functions, such as using the polynomial rolling hash function and the Rabin-Karp algorithm. In another embodiment, counting engine 202 uses the Java® String hashCode( ) method.

In another embodiment, counting engine 202 uses modular hashing to calculate a hash value for the string.

In one embodiment, counting engine 202 computes the hash values for each of the obtained strings representing the various relation paths of the knowledge graph.

After calculating the hash values for the strings using various hash algorithms, counting engine 202 counts the number of occurrences of the same hash value for each of the calculated hash values for various relation paths (represented by different strings), which represents the number of occurrences of a relation path. In one embodiment, counting engine 202 counts the number of occurrences of the same hash value using the COUNTIF function.

Counting engine 202 then selects the minimum number of occurrences of the same hash value to be used to identify the number of occurrences of the corresponding relation path (represented by a string) in the feature vector set.

For example, counting engine 202 counts the number of occurrences of the same hash value for each of the calculated hash values as represented by cᵢₚ=c[hᵢ(p)] for various p. For example, counting engine 202 counts the number of times the hash value of e0d123ef5316bef789bfdf5a008837577 was computed.

The minimum number of occurrences of the same hash value is then selected to represent the number of occurrences of the corresponding relation path (represented by the string associated with the hash value) in the feature vector set. For example, the selected minimum number of occurrences of the same hash value is represented by x(p)=min(cᵢₚ), which corresponds to the computed feature of x(p) of the path p, for each relation path p. For instance, if the minimum number of occurrences of the same hash value of e0d123ef5316bef789bfdf5a008837577 was one, then the count of the string (r5→r6→) associated with that relation path is 1.

Knowledge graph embedding generator 101 further includes a model generator 203 configured to build an artificial intelligence model (“prediction model”) using the feature vector set for each triple to predict an unknown direct relation path between two target nodes in the knowledge graph. In one embodiment, the prediction model predicts the unknown direct relation path between two target nodes in the knowledge graph by obtaining a feature vector set corresponding to the two target nodes, which includes the number of occurrences for various relation paths as well as a direct relation path.

In one embodiment, the prediction model receives two target nodes. In one embodiment, model generator 203 utilizes various algorithms, such as breadth-first and depth-first, to identify all the relation paths between the two target nodes in a knowledge graph, such as knowledge graph 300 of FIG. 3. In one embodiment, the prediction model receives a listing of the relation paths in connection with the provided two target nodes, such as via the user interface of knowledge graph embedding generator 101.

In one embodiment, model generator 203 instructs counting engine 202 to count the number of occurrences of each of the relation paths between the two target nodes in the same manner as discussed above. In one embodiment, the prediction model receives the number of occurrences of each of the relation paths between the two target nodes, such as via the user interface of knowledge graph embedding generator 101.

In one embodiment, based on the number of occurrences of the various relation paths of the target nodes, model generator 203 utilizes natural language processing to identify the feature vector set for the target nodes stored in the data storage device discussed above that matches the same target nodes with the most similar relation paths and most similar number of occurrences of such relation paths. For example, if the two target nodes were nodes A 301 and B 302 with relation paths r2, r3→>r4 and r5→>r7 with the number of occurrences of 1, 1 and 1, respectively, then model generator 203 may identify the feature vector set that includes relation paths r2, r3→r4 and r5→r6→r7 with the number of occurrences of 1, 1 and 1, respectively, for nodes A 301 and B 302 since such a feature vector set is directed to the same target nodes with the most similar relation paths and most similar number of occurrences of such relation paths. Such a feature vector set includes the direct relation path “r1” which is used by the prediction model to predict the unknown direct relation path (e.g., relation path “r1”) for target nodes A 301 and B 302.

In one embodiment, the feature vector set involving the target nodes with the most similar relation paths to the relation paths between the target nodes is identified by model generator 203 based on matching the greatest number of relation paths using natural language processing. In one embodiment, the most similar number of occurrences of such relation paths is identified by model generator 203 based on identifying a number of occurrences that is closest to the number of occurrences of the relation paths between the target nodes. In one embodiment, model generator 203 identifies the number of occurrences that is closest to the number of occurrences of the relation paths between the target nodes based on using the min( ) function. In one embodiment, a function is defined that calculates the difference between the number of occurrences for a relation path between the target nodes and the number of occurrences for that relation path in each feature vector set involving the target nodes. A call may then be made to the min( ) function to identify the closest value (out of the number of occurrences for the relation path in each feature vector set) to the number of occurrences for that relation path between the target nodes.

In this manner, the accuracy and efficiency of knowledge graph embedding is improved by the artificial intelligence mode (“prediction model”) identifying an unknown direct relation path between two target nodes in a knowledge graph more accurately and efficiently than prior techniques. The technique of the present disclosure utilizes fewer resources (e.g., processing and memory resources) while more accurately predicting the direct relation paths than prior techniques as evidenced by a higher mean reciprocal rank than prior techniques.

Furthermore, such an artificial intelligence model (“prediction model”) accurately predicts the unknown direct relation path between the two entities (two target nodes) in a knowledge graph thereby addressing the issue of whether the relation between the two entities of a triple may or may not be true (“link prediction”).

In one embodiment, such a model is built and trained using the feature vector set for each triple.

In one embodiment, model generator 203 uses a machine learning algorithm (e.g., supervised learning) to build the artificial intelligence model to predict the unknown direct relation path between two target nodes in the knowledge graph based on sample data consisting of the feature vector set for each triple.

Such a data set is referred to herein as the “training data,” which is used by the machine learning algorithm to make predictions or decisions as to the unknown direct relation path between two target nodes in the knowledge graph. The algorithm iteratively makes predictions on the training data as to the direct relation path between two target nodes in the knowledge graph until the predictions achieve the desired accuracy. Such a desired accuracy is determined based on the direct relation path predicted by an expert based on the feature vector sets for the triples. Examples of such supervised learning algorithms include nearest neighbor, Naïve Bayes, decision trees, linear regression, support vector machines and neural networks.

In one embodiment, the artificial intelligence model (machine learning model) corresponds to a classification model trained to predict the unknown direct relation path between two target nodes in the knowledge graph.

A further description of these and other functions is provided below in connection with the discussion of the method for accurately and efficiently performing knowledge graph embedding.

Prior to the discussion of the method for accurately and efficiently performing knowledge graph embedding, a description of the hardware configuration of knowledge graph embedding generator 101 (FIG. 1) is provided below in connection with FIG. 4.

Referring now to FIG. 4, FIG. 4 illustrates an embodiment of the present disclosure of the hardware configuration of knowledge graph embedding generator 101 (FIG. 1) which is representative of a hardware environment for practicing the present disclosure.

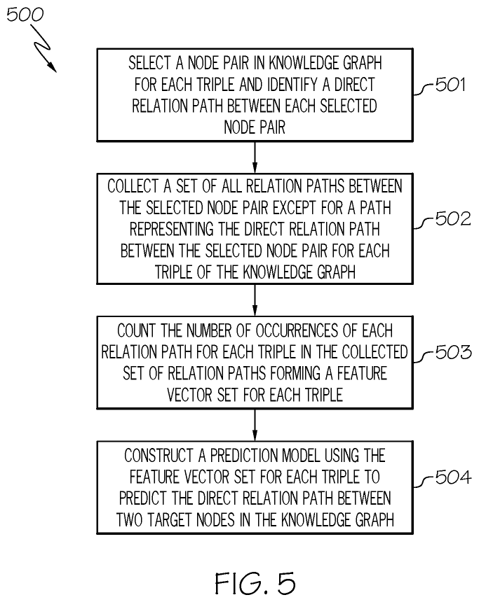

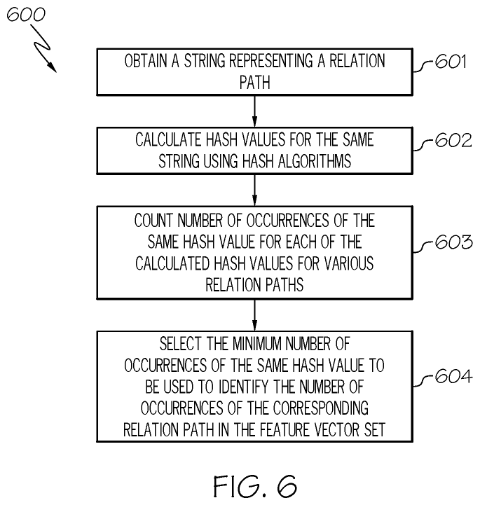

Knowledge graph embedding generator 101 has a processor 401 connected to various other components by system bus 402. An operating system 403 runs on processor 401 and provides control and coordinates the functions of the various components of FIG. 4. An application 404 in accordance with the principles of the present disclosure runs in conjunction with operating system 403 and provides calls to operating system 403 where the calls implement the various functions or services to be performed by application 404. Application 404 may include, for example, collecting engine 201 (FIG. 2), counting engine 202 (FIG. 2) and model generator 203 (FIG. 2). Furthermore, application 404 may include, for example, a program for accurately and efficiently performing knowledge graph embedding as discussed further below in connection with FIGS. 5 and 6.

Referring again to FIG. 4, read-only memory (“ROM”) 405 is connected to system bus 402 and includes a basic input/output system (“BIOS”) that controls certain basic functions of knowledge graph embedding generator 101. Random access memory (“RAM”) 406 and disk adapter 407 are also connected to system bus 402. It should be noted that software components including operating system 403 and application 404 may be loaded into RAM 406, which may be knowledge graph embedding generator's 101 main memory for execution. Disk adapter 407 may be an integrated drive electronics (“IDE”) adapter that communicates with a disk unit 408, e.g., disk drive. It is noted that the program for accurately and efficiently performing knowledge graph embedding, as discussed further below in connection with FIGS. 5 and 6, may reside in disk unit 408 or in application 404.

Knowledge graph embedding generator 101 may further include a communications adapter 409 connected to bus 402. Communications adapter 409 interconnects bus 402 with an outside network to communicate with other devices.

In one embodiment, application 404 of knowledge graph embedding generator 101 includes the software components of collecting engine 201, counting engine 202 and model generator 203. In one embodiment, such components may be implemented in hardware, where such hardware components would be connected to bus 402. The functions discussed above performed by such components are not generic computer functions. As a result, knowledge graph embedding generator 101 is a particular machine that is the result of implementing specific, non-generic computer functions.

In one embodiment, the functionality of such software components (e.g., collecting engine 201, counting engine 202 and model generator 203) of knowledge graph embedding generator 101, including the functionality for accurately and efficiently performing knowledge graph embedding, may be embodied in an application specific integrated circuit.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated above, a knowledge graph is a multi-relational graph composed of entities (nodes) and relations (edges). Each edge is represented by a triple of a form (e.g., head, relation, tail), also called a fact, indicating that two entities are connected by a specific relation. Although effective in representing structured data, the underlying symbolic nature of such triples usually makes knowledge graphs hard to manipulate. As a result, knowledge graph embedding has recently been utilized to address this issue. Knowledge graph embedding is a machine learning task of learning a low-dimensional representation of a knowledge graph's entities and relations while preserving their semantic meaning. Leveraging their embedded representation, knowledge graphs can be used for various applications, such as link prediction, triple classification, entity recognition, clustering and relation extraction. For example, knowledge graph embedding involves embedding components of a knowledge graph, including entities and relations, into continuous vector spaces so as to simplify the manipulation which preserving the inherent structure of the knowledge graph. Such entity and relation embedding can further be used to benefit many different types of tasks, such as entity classification, relation extraction, etc. Example algorithms for knowledge graph embedding include TransE (Translating Embeddings) and RotatE. In TransE, relationships are represented as translations in the embedding space. In RotatE, the RotatE model defines each relation as a rotation from the source entity to the target entity in a complex vector space. While such algorithms are simple and easy to use to perform knowledge graph embedding, the accuracy is poor. Alternatively, an attention-based neural network may be utilized to perform knowledge graph embedding. Unfortunately, such neural network models are complex to be utilized resulting in processor and memory inefficiencies. As a result, there is not currently a means for accurately and efficiently performing knowledge graph embedding.

The embodiments of the present disclosure provide a means for improving the accuracy and efficiency of performing knowledge graph embedding by using a prediction model to predict the unknown direct relation path between two target nodes of the knowledge graph as discussed below in connection with FIGS. 5 and 6. FIG. 5 is a flowchart of a method for improving the accuracy and efficiency of performing knowledge graph embedding. FIG. 6 is a flowchart of a method for counting the number of occurrences of a relation path.

As stated above, FIG. 5 is a flowchart of a method 500 for improving the accuracy and efficiency of performing knowledge graph embedding in accordance with an embodiment of the present disclosure.

Referring to FIG. 5, in conjunction with FIGS. 1-4, in step 501, collecting engine 201 of knowledge graph embedding generator 101 selects a node pair in a knowledge graph, such as knowledge graph 300, for each triple and identifies a direct relation path between each selected node pair. For example, referring to FIG. 3, nodes A 301 and B 302 of the triple (A, B, r1) may correspond to the selected node pair in which the relation path r1 is the direct relation path.

As discussed above, a “triple,” as used herein, refers to the form, also called a fact, which includes two entities as well as a relation connecting said two entities. An “entity,” as used herein, refers to the node of the knowledge graph, which may represent a person, a place, an object, etc. The term “entity” and “node” are used interchangeably herein. A “relation,” as used herein, refers to the edge or path of the knowledge graph that connects the nodes of the knowledge graph. As discussed above, a “direct relation” or a “direct relation path,” as used herein, refers to the relation path that directly connects two nodes in the knowledge graph in a closed loop in the shortest distance. A “closed loop,” as used herein, refers to a connection between two nodes in a knowledge graph in which the two nodes correspond to the end points of the connection.

In one embodiment, collecting engine 201 selects a node pair of the knowledge graph randomly. In one embodiment, collecting engine 201 receives user input to select the node pair of the knowledge graph, such as via the user interface of knowledge graph embedding generator 101.

In one embodiment, collecting engine 201 identifies the direct relation path by identifying the optimal path between the two nodes. Such an optimal path corresponds to the path that directly connects two nodes in the knowledge graph in a closed loop in the shortest distance. In one embodiment, collecting engine 201 utilizes the Bellman-Ford algorithm to identify such an optimal path. In another embodiment, collecting engine 201 utilizes the A* algorithm or Dijkstra' s algorithm to identify such an optimal path, which strategically eliminates paths, either through heuristics or through dynamic programming.

In step 502, collecting engine 201 of knowledge graph embedding generator 101 collects a set of all relation paths between the selected node pair except for the path representing the direct relation between the selected node pair for each triple of the knowledge graph, such as knowledge graph 300.

A drawback of knowledge representation-based models is that they only take semantic information implied by the single relations (1-hop paths), such as the direct relation paths, into consideration, thus ignoring the interpretation of multi-hop paths among the paired entities. As a result, collecting engine 201 performs multi-hop reasoning over the knowledge graph by collecting the set of all relation paths between the selected node pair in the knowledge graph except for the path representing the direct relation between the selected node pair. Such relation paths are collected by traversing the knowledge graph by “hopping” along with the relation in order to relate the two entities of the triple (i.e., the head entity and the tail entity).

For example, referring to FIG. 3, if the selected node pair in knowledge graph 300 was nodes A 301 and B 302 for the triple (A, B, r1), then collecting engine 201 collects the following relation paths between nodes A 301 and B 302 except for the path representing the direct relation between the selected node pair (r1): relation path r5→r6→r7, relation path r3→r4, and relation path r2.

As discussed above, in one embodiment, collecting engine 201 collects, for each triple, the set of all relation paths between two nodes of a triple of a knowledge graph, except for the path representing the direct relation between the two nodes, by defining every relation path with an associated path extension that consists of a pair of entities. For example, for the pair of entities A and B, collecting engine 201 follows a relation path P if the pair (A; B) is a member of the relation path extension PEXT(P). In one embodiment, the size of the relation path extension corresponds to the number of valid connecting paths for any pair of nodes in the knowledge graph.

In one embodiment, collecting engine 201 utilizes various algorithms, such as breadth-first and depth-first, to identify all the relation paths between the two nodes of a triple except for the path representing the direct relation. In one embodiment, such algorithms start from a given node (e.g., node A 301 in FIG. 3) and iterate over all potential paths until they reach the destination node (e.g., node B 302 in FIG. 3).

As also discussed above, in one embodiment, collecting engine 201 identifies the direct relation path so as to not collect the direct relation path by identifying the optimal path between the two nodes. Such an optimal path corresponds to the path that directly connects the two nodes in the knowledge graph in a closed loop manner in the shortest distance. In one embodiment, collecting engine 201 utilizes the Bellman-Ford algorithm to identify such an optimal path. In another embodiment, collecting engine 201 utilizes the A* algorithm or Dijkstra' s algorithm to identify such an optimal path, which strategically eliminates paths, either through heuristics or through dynamic programming.

In step 503, counting engine 202 of knowledge graph embedding generator 101 counts the number of occurrences of each relation path for each triple in the collected set of relation paths (see step 502) to be used to generate a feature vector set for each triple. Such a feature vector set corresponds to a feature vector of the multi-hop relation path. For example, as discussed above in connection with FIG. 3, collecting engine 201 collects the following relation paths for the triple (A, B, r1): relation path r5→r6→r7, relation path r3→r4, and relation path r2. Counting engine 202 counts the number of occurrences of each of these relations for the triple (A, B, r1). As shown in FIG. 3, each of these relation paths occur a single time. As a result, the feature vector set for such a triple includes the prediction of the relation path of r1 as being the direct relation path of nodes A 301 and B 302 when there is a count of 1 for the relation path r2, a count of 1 for the relation path r3→r4 and a count of 1 for the relation path r5→r6→r7. Such a feature vector set (as well as the feature vector sets for the other triples) will be used by the prediction model to predict the unknown direct relation path between two target nodes. For example, given a pair of target nodes (e.g., A 301, D 304), the prediction model will use the feature vector set corresponding to such target two nodes that includes the multi-hop relation path of the target nodes (or the closest to such a multi-hop relation path). For instance, after identifying (or being provided) the multi-hop relation path of the target nodes, the feature vector set involving such a set of relation paths (or the closest to such a set of relation paths), including the number of occurrences of such relation paths (or the closest to such a number of occurrences), is identified and the direct relation path associated with such a feature vector set will be used by the prediction model to predict the unknown direct relation path between the two target nodes.

In one embodiment, the number of occurrences of a relation path is identified by counting engine 202 using the method as discussed below in connection with FIG. 6.

FIG. 6 is a flowchart of a method 600 for identifying the number of occurrences of a relation path in accordance with an embodiment of the present disclosure.

Referring to FIG. 6, in conjunction with FIGS. 1-5, in step 601, counting engine 202 of knowledge graph embedding generator 101 obtains a string representing a relation path (p) of the knowledge graph.

As stated above, for example, the relation path between nodes A 301 and B 302 in FIG. 3 may be represented by the string r5→r6→r7. In one embodiment, such strings correspond to the relation paths in the collected set of relation paths prepared by collecting engine 201.

In one embodiment, counting engine 202 obtains multiple strings representing each relation path (p) of the knowledge graph, where such strings correspond to the different relation paths in the collected set of relation paths prepared by collecting engine 201. For example, the relation path between nodes A 301 and B 302 in FIG. 3 may be represented by the strings r5→r6→r7, r3→r4 and r2. The relation path between nodes A 301 and D 304 in FIG. 3 may be represented by the strings r5→r6, r3→r4→r7, and r2→r7.

After obtaining a string representing a relation path of the knowledge graph, in step 602, counting engine 202 of knowledge graph embedding generator 101 computes the hash values for the same string using multiple hash algorithms.

As discussed above, for example, counting engine 202 computes several hash values hᵢ(p) with seed i.

For example, in one embodiment, several different hash values are calculated for the string using different string hash functions, such as using the polynomial rolling hash function and the Rabin-Karp algorithm. In another embodiment, counting engine 202 uses the Java® String hashCode( ) method.

In another embodiment, counting engine 202 uses modular hashing to calculate a hash value for the string.

In one embodiment, counting engine 202 computes the hash values for each of the obtained strings representing the various relation paths of the knowledge graph.

After calculating the hash values for the same string using various hash algorithms, in step 603, counting engine 202 of knowledge graph embedding generator 101 counts the number of occurrences for the same hash value for each of the calculated hash values for various relation paths (represented by different strings), which represents the number of occurrences of a relation path. In one embodiment, counting engine 202 counts the number of occurrences of the same hash value using the COUNTIF function.

In step 604, counting engine 202 of knowledge graph embedding generator 101 selects the minimum number of occurrences of the same hash value to be used to identify the number of occurrences of the corresponding relation path (represented by a string) in the feature vector set.

As discussed above, for example, counting engine 202 counts the number of occurrences of the same hash value for each of the calculated hash values as represented by cᵢₚ=c[hᵢ(p)] for various p. For example, counting engine 202 counts the number of times the hash value of e0d123ef5316bef789bfdf5a008837577 was computed.

The minimum number of occurrences of the same hash value is then selected to represent the number of occurrences of the corresponding relation path (represented by the string associated with the hash value) in the feature vector set. For example, the selected minimum number of occurrences of the same hash value is represented by x(p)=min(cᵢₚ), which corresponds to the computed feature of x(p) of the path p, for each relation path p. For instance, if the minimum number of occurrences of the same hash value of e0d123ef5316bef789bfdf5a008837577 was one, then the count of the string (r5→r6→r7) associated with that relation path is 1.

Returning to FIG. 5, in conjunction with FIGS. 1-4 and 6, in step 504, model generator 203 of knowledge graph embedding generator 101 constructs a prediction model using the feature vector set for each triple to predict the unknown direct relation path between two target nodes in the knowledge graph by obtaining a feature vector set corresponding to the two target nodes. For example, if the two target nodes in the knowledge graph were A 301 and D 304, then the prediction model predicts the unknown direct relation path (e.g., direct relation path “r1”) between nodes A 301 and D 304 using the multi-hop relation path of the target nodes based on the feature vector set corresponding to these two target nodes that includes the multi-hop relation path (or most similar multi-hop relation path) of the target nodes as well as the number of occurrences (or most similar number of occurrences) of such relation paths between the two target nodes.

As discussed above, in one embodiment, the prediction model receives two target nodes. In one embodiment, model generator 203 utilizes various algorithms, such as breadth-first and depth-first, to identify all the relation paths between the two target nodes in a knowledge graph, such as knowledge graph 300 of FIG. 3. In one embodiment, the prediction model receives a listing of the relation paths in connection with the provided two target nodes, such as via the user interface of knowledge graph embedding generator 101.

In one embodiment, model generator 203 instructs counting engine 202 to count the number of occurrences of each of the relation paths between the two target nodes in the same manner as discussed above. In one embodiment, the prediction model receives the number of occurrences of each of the relation paths between the two target nodes, such as via the user interface of knowledge graph embedding generator 101.

In one embodiment, based on the number of occurrences of the various relation paths of the target nodes, model generator 203 utilizes natural language processing to identify the feature vector set for the target nodes stored in the data storage device (e.g., memory 405, disk unit 408) discussed above that matches the same target nodes with the most similar relation paths and most similar number of occurrences of such relation paths. For example, if the two target nodes were nodes A 301 and B 302 with relation paths r2, r3→r4 and r5→r7 with the number of occurrences of 1, 1 and 1, respectively, then model generator 203 may identify the feature vector set that includes relation paths r2, r3→r4 and r5→r6→r7 with the number of occurrences of 1, 1 and 1, respectively, for nodes A 301 and B 302 since such a feature vector set is directed to the same target nodes with the most similar relation paths and most similar number of occurrences of such relation paths. Such a feature vector set includes the direct relation path “r1” which is used by the prediction model to predict the unknown direct relation path (e.g., relation path “r1”) for target nodes A 301 and B 302.

In one embodiment, the feature vector set involving the target nodes with the most similar relation paths to the relation paths between the target nodes is identified by model generator 203 based on matching the greatest number of relation paths using natural language processing. In one embodiment, the most similar number of occurrences of such relation paths is identified by model generator 203 based on identifying a number of occurrences that is closest to the number of occurrences of the relation paths between the target nodes. In one embodiment, model generator 203 identifies the number of occurrences that is closest to the number of occurrences of the relation paths between the target nodes based on using the min( ) function. In one embodiment, a function is defined that calculates the difference between the number of occurrences for a relation path between the target nodes and the number of occurrences for that relation path in each feature vector set involving the target nodes. A call may then be made to the min( ) function to identify the closest value (out of the number of occurrences for the relation path in each feature vector set) to the number of occurrences for that relation path between the target nodes.

In this manner, the accuracy and efficiency of knowledge graph embedding is improved by the artificial intelligence mode (“prediction model”) identifying an unknown direct relation path between two target nodes in a knowledge graph more accurately and efficiently than prior techniques. The technique of the present disclosure utilizes fewer resources (e.g., processing and memory resources) while more accurately predicting the direct relation paths than prior techniques as evidenced by a higher mean reciprocal rank than prior techniques.

Furthermore, such an artificial intelligence model (“prediction model”) accurately predicts the unknown direct relation path between the two entities (two target nodes) in a knowledge graph thereby addressing the issue of whether the relation between the two entities of a triple may or may not be true (“link prediction”).

In one embodiment, such a model is built and trained using the feature vector set for each triple.

In one embodiment, model generator 203 uses a machine learning algorithm (e.g., supervised learning) to build the artificial intelligence model to predict the unknown direct relation path between two target nodes in the knowledge graph based on sample data consisting of the feature vector set for each triple.

Such a data set is referred to herein as the “training data,” which is used by the machine learning algorithm to make predictions or decisions as to the unknown direct relation path between two target nodes in the knowledge graph. The algorithm iteratively makes predictions on the training data as to the direct relation path between two target nodes in the knowledge graph until the predictions achieve the desired accuracy. Such a desired accuracy is determined based on the direct relation path predicted by an expert based on the feature vector sets for the triples. Examples of such supervised learning algorithms include nearest neighbor, Naïve Bayes, decision trees, linear regression, support vector machines and neural networks.

In one embodiment, the artificial intelligence model (machine learning model) corresponds to a classification model trained to predict the unknown direct relation path between two target nodes in the knowledge graph.

In this manner, the principles of the present disclosure more accurately and efficiently perform knowledge graph embedding than prior techniques. For instance, the accuracy and efficiency of knowledge graph embedding is improved by identifying an unknown direct relation path between two target nodes in a knowledge graph more accurately and efficiently than prior techniques. By utilizing the principles of the present disclosure, fewer processing and memory resources need to be utilized to perform knowledge graph embedding as evidenced by a higher mean reciprocal rank than prior techniques.

Furthermore, the principles of the present disclosure improve the technology or technical field involving knowledge representation and reasoning.

As discussed above, a knowledge graph is a multi-relational graph composed of entities (nodes) and relations (edges). Each edge is represented by a triple of a form (e.g., head, relation, tail), also called a fact, indicating that two entities are connected by a specific relation. Although effective in representing structured data, the underlying symbolic nature of such triples usually makes knowledge graphs hard to manipulate. As a result, knowledge graph embedding has recently been utilized to address this issue. Knowledge graph embedding is a machine learning task of learning a low-dimensional representation of a knowledge graph's entities and relations while preserving their semantic meaning. Leveraging their embedded representation, knowledge graphs can be used for various applications, such as link prediction, triple classification, entity recognition, clustering and relation extraction. For example, knowledge graph embedding involves embedding components of a knowledge graph, including entities and relations, into continuous vector spaces so as to simplify the manipulation which preserving the inherent structure of the knowledge graph. Such entity and relation embedding can further be used to benefit many different types of tasks, such as entity classification, relation extraction, etc. Example algorithms for knowledge graph embedding include TransE (Translating Embeddings) and RotatE. In TransE, relationships are represented as translations in the embedding space. In RotatE, the RotatE model defines each relation as a rotation from the source entity to the target entity in a complex vector space. While such algorithms are simple and easy to use to perform knowledge graph embedding, the accuracy is poor. Alternatively, an attention-based neural network may be utilized to perform knowledge graph embedding. Unfortunately, such neural network models are complex to be utilized resulting in processor and memory inefficiencies. As a result, there is not currently a means for accurately and efficiently performing knowledge graph embedding.

Embodiments of the present disclosure improve such technology by selecting a node pair for each triple of a knowledge graph and identifying a direct relation path between the selected node pair. A “triple” of the knowledge graph, as used herein, refers to the form, also called a fact, which includes two entities as well as a relation connecting the two entities. An “entity,” as used herein, refers to the node of the knowledge graph, which may represent a person, a place, an object, etc. The term “entity” and “node” are used interchangeably herein. A “relation,” as used herein, refers to the edge or path of the knowledge graph that connects the nodes of the knowledge graph. A “direct relation path,” as used herein, refers to the relation path that directly connects two nodes in the knowledge graph in a closed loop in the shortest distance. A “closed loop,” as used herein, refers to a connection between two nodes in a knowledge graph in which the two nodes correspond to the end points of the connection. Furthermore, for each triple of the knowledge graph, a set of relation paths between the selected node pair is collected except for the path representing the direct relation path. The number of occurrences of each relation path for each triple in the collected set of relation paths is counted thereby forming a feature vector set for each triple, where the feature vector set includes a set of occurrences of each relation path for a node pair along with a corresponding direct relation path. A prediction model is then constructed using the feature vector set for each triple to predict an unknown direct relation path between two target nodes in the knowledge graph by obtaining a feature vector set corresponding to the two target nodes, which includes the number of occurrences for various relation paths as well as a direct relation path. Based on obtaining the number of occurrences of each relation path connecting the two target nodes, the unknown direct relation path can be predicted for the two target nodes based on obtaining the feature vector set of the two target nodes containing the number of occurrences (or most similar number of occurrences) of each relation path (or most similar relation path) connecting the two target nodes. In this manner, knowledge graph embedding is performed more accurately and efficiently than prior techniques. The technique of the present disclosure utilizes fewer resources (e.g., processing and memory resources) while more accurately predicting the direct relation paths than prior techniques as evidenced by a higher mean reciprocal rank than prior techniques. Furthermore, in this manner, there is an improvement in the technical field involving knowledge representation and reasoning.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for knowledge graph embedding, the method comprising:
selecting a node pair for each triple of a knowledge graph and identifying a direct relation path between said node pair, wherein said triple of said knowledge graph comprises a first and a second node each representing an entity connected by a specific relation path;
collecting a set of relation paths between said node pair except for a path representing said direct relation path for each triple of said knowledge graph;
counting a number of occurrences of each relation path for each triple in said collected set of relation paths thereby forming a feature vector set for each triple, wherein said feature vector set comprises a set of occurrences of each relation path for a node pair along with a corresponding direct relation path; and
constructing a prediction model by using said feature vector set for each triple to predict a direct relation path between two target nodes in said knowledge graph by obtaining a feature vector set corresponding to said two target nodes.

2. The method as recited in claim 1, wherein each relation path of said set of relation paths forms a closed loop in said knowledge graph.

3. The method as recited in claim 1, wherein each relation path of said set of relation paths does not include node information.

4. The method as recited in claim 1 further comprising:
obtaining a string representing a relation path.

5. The method as recited in claim 4 further comprising:
calculating hash values for said string.

6. The method as recited in claim 5, wherein said hash values are calculated using a plurality of hash algorithms.

7. The method as recited in claim 5 further comprising:
counting a number of occurrences of a same hash value for each of said calculated hash values.

8. The method as recited in claim 7 further comprising;
selecting a minimum number of occurrences of said same hash value to be used to identify a number of occurrences of a corresponding relation path in said feature vector set for a triple.

9. The method as recited in claim 1, wherein said prediction model corresponds to a decision tree.

10. A computer program product for knowledge graph embedding, the computer program product comprising one or more computer readable storage mediums having program code embodied therewith, the program code comprising programming instructions for:
selecting a node pair for each triple of a knowledge graph and identifying a direct relation path between said node pair, wherein said triple of said knowledge graph comprises a first and a second node each representing an entity connected by a specific relation path;
collecting a set of relation paths between said node pair except for a path representing said direct relation path for each triple of said knowledge graph;
counting a number of occurrences of each relation path for each triple in said collected set of relation paths thereby forming a feature vector set for each triple, wherein said feature vector set comprises a set of occurrences of each relation path for a node pair along with a corresponding direct relation path; and
constructing a prediction model by using said feature vector set for each triple to predict a direct relation path between two target nodes in said knowledge graph by obtaining a feature vector set corresponding to said two target nodes.

11. The computer program product as recited in claim 10, wherein each relation path of said set of relation paths forms a closed loop in said knowledge graph.

12. The computer program product as recited in claim 10, wherein each relation path of said set of relation paths does not include node information.

13. The computer program product as recited in claim 10, wherein the program code further comprises the programming instructions for:
obtaining a string representing a relation path.

14. The computer program product as recited in claim 13, wherein the program code further comprises the programming instructions for:
calculating hash values for said string.

15. The computer program product as recited in claim 14, wherein said hash values are calculated using a plurality of hash algorithms.

16. The computer program product as recited in claim 14, wherein the program code further comprises the programming instructions for:
counting a number of occurrences of a same hash value for each of said calculated hash values.

17. The computer program product as recited in claim 16, wherein the program code further comprises the programming instructions for:
selecting a minimum number of occurrences of said same hash value to be used to identify a number of occurrences of a corresponding relation path in said feature vector set for a triple.

18. The computer program product as recited in claim 10, wherein said prediction model corresponds to a decision tree.

19. A system, comprising:
a memory for storing a computer program for knowledge graph embedding; and
a processor connected to said memory, wherein said processor is configured to execute program instructions of the computer program comprising:
selecting a node pair for each triple of a knowledge graph and identifying a direct relation path between said node pair, wherein said triple of said knowledge graph comprises a first and a second node each representing an entity connected by a specific relation path;
collecting a set of relation paths between said node pair except for a path representing said direct relation path for each triple of said knowledge graph;
counting a number of occurrences of each relation path for each triple in said collected set of relation paths thereby forming a feature vector set for each triple, wherein said feature vector set comprises a set of occurrences of each relation path for a node pair along with a corresponding direct relation path; and
constructing a prediction model by using said feature vector set for each triple to predict a direct relation path between two target nodes in said knowledge graph by obtaining a feature vector set corresponding to said two target nodes.

20. The system as recited in claim 19, wherein each relation path of said set of relation paths forms a closed loop in said knowledge graph.

21. The system as recited in claim 19, wherein each relation path of said set of relation paths does not include node information.

22. The system as recited in claim 19, wherein the program instructions of the computer program further comprise:
obtaining a string representing a relation path.

23. The system as recited in claim 22, wherein the program instructions of the computer program further comprise:
calculating hash values for said string.

24. The system as recited in claim 23, wherein said hash values are calculated using a plurality of hash algorithms.

25. The system as recited in claim 23, wherein the program instructions of the computer program further comprise:
counting a number of occurrences of a same hash value for each of said calculated hash values.
